(19) United States
(12) Patent Application Publication
(10) Pub. No.: US 2023/0113697 A1
(43) Pub. Date: Apr. 13, 2023

(54) Biodegrading recalcitrant to biodegradation organic substances

(71) Applicant: Timothy Eugene Dunn, Arlington, WA (US)

(72) Inventor: Timothy Eugene Dunn, Arlington, WA (US)

(21) Appl. No.: 16/950,921

(22) Filed: Nov. 18, 2020

(51) Int. Cl. C02F 3/34; B09B 3/00

(52) U.S. Cl. CPC C02F 3/342; C02F 3/341; C02F 3/348; C02F 3/345; B09B 3/00; C02F 3/347; C02F 2101/101

(57) ABSTRACT

A composition for stimulating the production and excretion of a lignolytic enzyme in a microorganism for degrading harmful substances and/or in the manufacturing of easily degradable ester containing plastics or articles made of ester containing plastic. The composition mainly includes tributyrin, triolein, fish oil, 16-hydroxyhexadecanoic acid, n-aliphatic primary fatty alcohols, polycaprolactone, aliphatic polyesters, linolenic acid, linoleic acid, alpha linolenic acid, plant polyesters, cutin, cutin derivatives, cutin monomers, omega hydroxy acids, 16-hydroxy palmitic acid, 9,16-dihydroxypalmitic acid, 10,16-dihydroxypalmitic acid, C18-hydroxy oleic acid, 9,10-epoxy-18-hydroxy stearic acid, 9,10,18-trihydroxystearate, suberin, cork, fruit skins, vegetable skins, and their constituents and derivatives, hydroxy fatty acids, 16-hydroxy palmitic acid, 18-hydroxy stearic acid, juniperic acid, hexadecanol, linseed oil, perilla oil, amides, acetamide and N-acetyl amide, zinc, zinc salts, butyrate, acetate, lactate, manganese peroxidase, and carbamide peroxide.

### BACKGROUND

There are many organic substances which are problematic for humans, wildlife, the environment, and vital infrastructure. Many of these substances are recalcitrant to biodegradation, and many are toxic. Some such substances are harmful to the purity of water, soil, and the environment. Other such substances are problematic because they are indigestible, and fill the digestive tracts of fish, birds, and marine animals, inhibiting the digestion of food. Plastic fragments, usually caused by plastic mulch degradation in farming fields, are problematic because they reduce the adsorption of water and air into the soil. Biodegrading or altering these substances into harmless substances at faster rates than nature can accomplish unassisted offers very important benefits to people, animals, and nature itself.

### SUMMARY OF THE INVENTION

Many problematic substances, which are organic, yet which are resistant to biodegradation, (mineralization,) may be biodegraded via the appropriate biological processes, which involve the enzymes of microbes and plants as well as those of animals, insects, yeasts, blue-green algae, and fungi. Embodiments of the invention stimulate the production, or increase the production, of enzymes and substances which assist the enzymes that biodegrade recalcitrant to biodegradation problematic organic substances. In some cases, the enzymes involved are commercially available, and can be used directly to biodegrade the applicable substance via admixture. In other cases, the enzymes and their auxiliary substances may be stimulated to be produced from wild microorganisms which are found in the vicinity in which biodegradation of the undesired substances is desired. In yet another class of embodiments of the invention, the microorganisms which will produce the desired exoenzymes and their auxiliary excreted substances, may be cultured and introduced into the environment in which the biodegradation of the undesired substance is desired, and the biodegradation via these enzymes and auxiliary substances may be stimulated by appropriate enzyme stimulating substances. In this patent application, various formulas and microbes and auxiliary substances are delineated, which are optimum for the biodegradation of specific substances which are desired to be bioremediated.

Many substances, including but not limited to, conventional synthetic plastics, including, but not limited to, pure hydrocarbons, can be biodegraded by ligninolytic enzyme systems and the microorganisms which excrete these systems. Hydrocarbon-containing plastics, including but not limited to polyolefins, include, but are not limited to, polystyrenes, polyethylene, polypropylene, polycarbonates, and conventional synthetic plastics which are not pure hydrocarbons, including but limited to nitrogen-containing polyamides, polyvinyl chlorides.

Furthermore, many other organic substances which are problematic, and resistant to biodegradation, can be biodegraded by ligninolytic systems. These substances include, but are not limited to, kraft lignin, petroleum and its products, including but not limited to, toxins including but not limited to, polyaromatic hydrocarbons, PCBs, BTEX toxins, herbicides, pesticides, antibiotics, BPA and other phthalates, dyes based on petroleum or coal based substances, and substances containing phenols, including but not limited to, creosote and olive oil mill wastes.

The reason that it is very widely believed, even by many microbiologists, that these substances are non-biodegradable, is that most of these substances do not contain chemicals which stimulate the production and excretion of ligninolytic systems. If chemical stimulators for the stimulation of the production and excretion of ligninolytic enzymes and ligninolytic auxiliary substances are present, these allegedly non-biodegradable substances are readily biodegraded, by the production and excretion of radicalized substances produced by ligninolytic systems. Claiming substances which stimulate the ligninolytic system's production and excretion is therefore a novel and unexpected part of this invention which concerns biodegrading substances which are biodegraded by ligninolytic systems, that is, independent claim 1, and dependent claims 2, 3, and 4.

Embodiments of the invention can be incorporated in articles such as plastic products while they are being manufactured, or they can be admixed with recalcitrant to biodegradation substances, such as admixture in the environment, where they are problematic due to their admixture with the environment, as in petroleum spills in the water or groundwater, including but not limited to, in the ocean, or in the pollution of soil, or in wastewater. Embodiments of the invention can also be used in the process of treating industrial wastes, including but not limited to, industrial wastewater.

### Ligninolytic Enzymes and Auxiliary Excreted Ligninolytic Substances Biodegrade Many Recalcitrant-to-Biodegradation Organic Substances

Ligninolytic systems include exoenzymes, including but not limited to, laccases and peroxidases, including but not limited to manganese peroxidases, lignin peroxidases, versatile peroxidase, horseradish peroxidase, and other peroxidases containing, but not limited to, other transition metal bearing peroxidases, such as copper, iron and zinc bearing peroxidases, as well as auxiliary enzymes and substances, including but not limited to, organic acids, aryl alcohol oxidases, glyoxyl oxidases, and glucose oxidases. Noted for excreting these enzyme systems are ligninolytic fungi, including but not limited to, white rot fungi, which are especially noted for biodegrading lignin, including but not limited to, many oxidative enzyme-producing Ascomycetes, Deuteromycetes, and Basidiomycetes (white rot) fungi. White rot is an informal name which refers to the visual effect these fungi have on wood, giving a white appearance to the rotted wood because they biodegrade lignin in preference to cellulose. Lignin is reddish, and cellulose is whitish.

Lignin is found in many kinds of plants, including trees and grasses. For this reason, ligninolytic microorganisms are ubiquitous. Lignin is very resistant to biodegradation, compared to other plant components, such as hemicellulose, cellulose and sugars. Also excreted to assist this biodegradation of lignin, aside from the above mentioned enzymes, are organic acids and their salts, including, but not limited to, oxalic, malonic, malic, citric and formic acids, as well as salts or esters of organic acids. Alcohols such as veratryl alcohol and aryl alcohols also assist the production of H2O2, which is then radicalized into oxygen-containing radicals, and glucose oxidase, which can also produce H2O2 from glucose. There is no widespread consensus of exactly how organic acids assist ligninolysis, but it is widely agreed that they do so. It has been speculated that organic acids are an oxygen source for the production of oxygen radicals, which are used by microorganisms to biodegrade recalcitrant to biodegradation substances, including but not limited to, lignin and toxins. These ligninolytic enzymatic systems are excreted by these microorganisms, which include but are not limited to, fungi, yeasts, and bacteria.

In addition to these acids and aryl alcohols, enzymes for which these aryl alcohols and acids are substrates assist in the biodegradation of lignin, plastics, petroleum and its products, including but not limited to, toxins, including but not limited to, polyaromatic hydrocarbons, PCBs, BTEX toxins, creosote, olive oil mill wastes, herbicides and pesticides, antibiotics, BPA and other phthalates, and dyes based on petroleum based substances.

All of these difficult to biodegrade organic substances are especially prone to biodegradation by radicalized substances, including but not limited to oxygen radicals. It is the resulting oxygen radicals that are most especially prominent in biodegrading these substances, via complex reactions caused by interactions within ligninolytic enzymatic systems, which result in the production of radicals, most importantly, oxygen radicals. In many cases, these oxygen radicals are generated from hydrogen peroxide, which is created by complex processes involving aryl alcohol oxidase, glucose oxidase, and glyoxal oxidase.

Prominent among these auxiliary enzymes in the ligninolytic systems excreted are aryl alcohol oxidases, which oxidize aryl alcohols, and glyoxal oxidase enzymes, which metabolize small aldehydes. Aryl alcohol production and excretion is a part of the ligninolytic system in many fungi and microorganisms. These oxidases, when excreted, generate H2O2, which is subsequently radicalized to oxygen containing radical species by ligninolytic enzymes, including but limited to, laccase, manganese peroxidase and lignin peroxidase. Mineral substances, including, but not limited to, manganese ions, are also excreted in order to facilitate this biodegradative process by becoming ingredients for the production of manganese peroxidase.

A number of inventions have claimed what they describe as oxidant or prodegradant compounds, in the form of transition metal compounds, but these inventions claim relatively large amounts of transition metal compounds, to cause oxodegradation, which is a method of stimulating a destructive cascade of radicals, caused by the effect heat or ultraviolet light on some transition metal compounds, supplied in relatively large quantities. The invention disclosed herein use much smaller amounts of transition metal nutrients, in the form of salts, as trace nutrients, such as are found in vitamin and mineral supplements for humans and livestock, or in basal salt media, used to nourish microorganisms for microbiology experiments. Transition metal compounds also stimulate the production and excretion of enzymes of which trace transition metals are constituents. No embodiment of the invention claimed herein requires any exposure to elevated heat or ultraviolet light at all, to cause biodegradation of recalcitrant to biodegradation organic substances.

All embodiments of the invention claimed herein function best at temperatures between 10 and 35 degrees C., and they function as well in darkness as well as they do under UV light. Since oxodegradable compound-treated conventional synthetic plastic products normally are buried in landfills, or occasionally in commercial compost heaps, they are typically not degraded after being disposed of, and thus are not biodegraded in any measurable amount. Oxodegradation initiated by heat typically requires elevated temperatures well above ambient temperatures, 57 C or more typically being necessary to result in mineralization of the synthetic plastic which incorporates oxodegradable additives, which include many thousands of times more transition metals by percentage than embodiments of the invention disclosed herein.

A number of microbes are also noted for excreting ligninolytic systems which will degrade the conventional plastics and other substances, also called substrates, mentioned in this section of this patent application, said microbes include but are not limited to, Bacillus species, Penicillin species, Burkholderia species, Pseudomonas species, Streptomyces species, Rhodococcus species, and many more bacterial genera and species which can biodegrade lignin. Classes of organisms which biodegrade lignin include but are not limited to, bacteria, fungi, yeasts and blue green algae.

It is likely that the primary function of fungal ligninolytic enzyme systems is to penetrate lignin barriers in plants, in order to access cellulose, hemicellulose, and sugars, which are food sources for ligninolytic fungi. It is likely that the primary function of ligninolytic systems in bacteria is to detoxify microbes' immediate surroundings, to protect the bacteria from toxins.

### DETAILED DESCRIPTION

The admixture of certain commercially available substances, as well as agricultural byproducts, will cause ligninolytic microorganisms to excrete the ligninolytic systems, resulting in the biodegradation of many unwanted organic substances, including but limited to, hydrocarbon plastics and many petroleum and natural gas based substances, including but not limited to, synthetic plastics, petroleum, gasoline, diesel, polyaromatic hydrocarbons, lubricating oils, aniline dyes, PCBs, BTEX toxins, bisphenols, phthalates, creosote, olive oil mill wastes, herbicides, pesticides, antibiotics, plant pitch, phenolic substances, explosives and their derivatives, lignin, and lignin derivatives and metabolites, including but not limited to, kraft lignins and black liquor.

Substances which stimulate the production and excretion of, or which increase the ligninolytic system production and excretion include, but are not limited to: Explosives and their metabolites, including but not limited to trinitrotoluene, polysorbate 80, ethanol, salts of transition metals, including but not limited to iron, copper, and manganese, and many organic substances which include a phenolic moiety, including but not limited to, phenolic compounds containing one or more methoxy phenolic moieties, including but not limited to, a phenol in which there are two methoxy groups attached, including but not limited to, one methoxy moiety one each side of the hydroxyl group attached to the benzene ring, not including acetosyringone, including but not limited to, kraft lignins, guaiacol, syringaldehyde, vanillin, acetovanillone, p-coumaric acid, ferulic acid, sinapic acid, coumarin, catechol, orcinol, resorcinol, eugenol, pyrogallol, acetaminophen, tannic acid, 2,5-xylidine, and many more similar compounds.

Phenolic substances, (substances in which a benzene ring has at least one hydroxy group attached to the benzene ring,) contribute to a chain of radical production, a chain reaction of radicalization by being themselves subject to being radicalized, typically first into phenoxy radicals, then in turn creating more powerful oxygen radicals, in a chain of reactions in which radicals impact and radicalize other oxygen containing substances. Linoleic acid can also contribute to the creation of radicals, due to being prone to radicalization at its unsaturated bonds, by hydrogen abstraction. The drying oils are especially prone to this form of radical creation by hydrogen abstraction at the unsaturated carbon to carbon bonds, even being able to auto-oxidize, thus initiating a cascade of oxygen radical production.

The best way to biodegrade these substances is to admix the ligninolytic system stimulating chemicals in a moist environment containing ligninolytic microorganisms, by stimulating wild microorganisms or cultured ligninolytic microorganisms with chemical stimulators of the ligninolytic systems' production and excretion. The process would be further enhanced by mixing in basal salt mixtures, including but not limited to, Murishige and Skoog's, and readily assimilated carbon sources, including but not limited to fatty acids, cellulose, polyols, starches, sugars and polymers of sugars, and nitrogen containing substances, including but not limited to, ammonium nitrate, ammonium tartrate, ammonium sulfate, urea, ammonia, and B vitamins, including but not limited to, thiamine, biotin, or thiamine and biotin containing substances, to nourish the microorganisms.

These nutrient mixtures can nourish ligninolytic bacteria, ligninolytic yeast, and ligninolytic fungi. The process would be further improved by supplying additional (that is moderately more than is usually found in basal salt mixtures,) but still vert minute amounts of bioassimilable mineral salts of transition metals, including but not limited to, salts of iron, copper and manganese, including but not limited to, sulfur salts thereof.

Below is an effective embodiment of the invention for biodegrading substances subject to biodegradation by ligninolytic systems, when admixed with these substances in an environment that is moist or wet, and slightly aerated, and containing colonies of ligninolytic microbes, fungi, or blue green algae, sufficient to biodegrade one metric ton of the substance to be biodegraded. The amount of the invention needed to cause effective biodegradation of recalcitrant to biodegradation substances is relatively small, less than 3% of the weight of the substance to be biodegraded. The figures are in kilograms per ton of substrate.
cellulose 15
polysorbate 80 1.65
raw linseed oil 1.008
guaiacol 1.5
vanillin 1.5
refined glycerol 1.5
potassium sulfate, anhydrous 1.4944
calcium chloride anhydrous 0.30496
potassium phosphate monobasic 0.16684
magnesium sulfate 0.1584
calcium carbonate 0.09296
ammonium tartrate 0.09296
manganese sulfate 0.08936
zinc sulfate 0.00772
boric acid 0.00548
potassium iodide 0.00076
thiamine hydrochloride 0.001
molybdenum disulfide 0.0002234
ferrous sulfate 0.00003488
cobalt chloride 0.00000222
copper sulfate pentahydrate 0.00000222
sodium benzoate 0.00000222

In one embodiment of the invention for use in conventional synthetic plastic products, an effective way of admixing the above formula in plastics which do not contain oxygen or nitrogen in their molecular structure is to make pellets of the plastics with compatibilizers that make non polar plastics compatible with polar ingredients, in which the embodiment is mixed with compatibilized plastics in higher concentrations than is intended in the end product. Such compatibilizers are available commercially from a variety of vendors. These compatibilizers are commonly available in pellets, and they usually consist of nonpolar plastics that have been modified by covalently bonding the plastic with oxygen containing groups, including but not limited to, maleic anhydride, glycidyl methacrylate, and acrylic esters. These pellets, containing higher concentrations of the embodiment than intended to be used in finished products, are meant to be later mixed with plastics lacking oxygen containing groups and otherwise lacking the embodiment.

The embodiment of the invention is effectively combined with the compatibilizer in a machine, including but not limited to, a twin screw extruder, which melts, mixes, and pelletizes the compatibilizer and the embodiment of the invention. Subsequently, the plastic to be biodegraded is admixed with the pellets consisting of a compatibilizer and the embodiment of the invention, in a machine which melts and mixes the embodiment pellets and the plastic pellets. The resulting pellets are then turned into end products by methods known to those skilled in the art of thermoplastic manufacturing. Such end products are everyday products meant to have a useful lifespan of less than one year, including but not limited to, plastic shopping bags, disposable eating utensils, packaging for food and other commercial products, bottles, straws, cups, cup lids, stirrers, stretch wrap, etc.

### Biodegrading Ester Group Containing Substances

Plastics containing ester moieties are somewhat resistant to biodegradation by ligninolytic systems, probably because of hydrogen bonding within ester-containing plastics, mutually reinforcing their long molecules, making them resistant to biodegradation by oxygen radicals.

Oxygen containing plastics, containing ester moieties, including but not limited to polyethylene terephthalate, epoxy resins, polyethylene furanoate, polytrimethylene furandicarboxylate, acrylate plastics, methyl methacrylate, sodium polyacrylate, and polylactic acid can be biodegraded by esterases, including but not limited to, cutinase.

Cutinase is a natural poleyesterase enzyme, the natural function of which is to biodegrade the natural polyester coating of leaves and bark. Because leaves and bark are ubiquitous, microorganisms which can biodegrade natural polyesters are ubiquitous. Once the leaves and bark have been penetrated, the microorganisms which excrete the cutinase have access to the cellulose, hemicellulose, and sugars found within the plant, which are food sources for the fungi and bacteria. The microorganisms which excrete cutinase, include but are not limited to, fungal plant pathogens, which include but are not limited to, Fusarium species, Magnaportha species, Colletotrichum species, and a few bacteria species.

Plant pathogens are ubiquitous, and they may be stimulated into excreting esterases, including but not limited to, cutinase, by substances which are constituents of plant cutin, or which resemble constituents of plant cutin. Examples of this are 16-hydroxyhexadecanoic acid, polysorbate 80, and linoleic acid, which stimulate this excretion, resulting in the biodegradation of ester group containing substances, including but not limited to, plastics, by means of severing the ester groups from the carbon atoms to which it is bonded. The resulting severed moieties are readily biodegraded by many microorganisms.

The process would be further enhanced by mixing in basal salts and readily assimilated carbon and nitrogen sources. These nutrient mixtures can nourish lipase and cutinase excreting organisms and microorganisms. The process would be further improved by supplying additional mineral salts of transition metals, including but not limited to salts of zinc, which is a constituent of cutinase, and of nonionic surfactants, including but not limited to, polysorbate 80 and 20, which increase the permeability of cell walls.

Here is an effective embodiment of the invention for biodegrading substances subject to biodegradation by cutinase or lipases, when admixed with these substances in an environment that is moist or wet, and containing colonies of cutinase or lipase excreting fungi or bacteria, including but not limited to plant pathogens, sufficient to biodegrade one metric ton of the substance to be biodegraded. The figures are in kilograms per ton of substrate.
Cellulose 15
polysorbate 80 1.65
Refined glycerol 1.5
flaxseed oil 5
16-hydroxyhexadecanoic acid 0.8
potassium sulfate, anhydrous 1.4944
calcium chloride anhydrous 0.30496
potassium phosphate monobasic 0.1584
magnesium sulfate 0.1506
calcium carbonate 0.09296
ammonium tartrate 0.08936
manganese sulfate 0.01544
zinc sulfate 0.00772
boric acid 0.00548
potassium iodide 0.00076
thiamine hydrochloride 0.001
molybdenum disulfide 0.0002234
ferrous sulfate 0.00003488
cobalt chloride 0.00000222
copper sulfate pentahydrate 0.00000222
sodium benzoate 0.00000222

In an ester biodegrading embodiment of the invention, an optional method of admixing the above formula in plastics is to admix it with the kind of plastic containing oxygen or nitrogen to be biodegraded, in which the embodiment is mixed with plastics in higher concentrations than is intended in the end product, while the plastic is in a melted state. The embodiment of the invention is effectively combined with the oxygen or nitrogen containing synthetic plastic in a machine, including but limited to, a twin screw extruder or Brabender mixer, which melts, mixes, and pelletizes the compatibilizer and the embodiment of the invention. Subsequently, the plastic to be biodegraded is admixed with the embodiment containing pellets with more melted pellets of the plastic to be biodegraded, and the embodiment of the invention. The resulting pellets are then turned into end products by methods known to those skilled in the art of thermoplastic manufacturing, the end products including but not limited to, PET bottles.

The formula above can be used in many embodiments for the biodegradation of various substances, but substituting the correct stimulators for the flaxseed oil and 16-hydroxyhexadecanoic acid listed above in similar amounts, the different stimulators as delineated in the claims, according to the specific substance to be biodegraded, as per those in the claims attached to this patent application, those independent claims being numbered 12 and 15.

### Biotransformation of Hydrogen Sulfide, to Prevent its Transformation to H2SO4 by Microbes

Superoxide dismutase, a ubiquitous enzyme known for rendering oxygen radicals less harmful, alters hydrogen sulfide into harmless substances which do not contribute to concrete erosion.

Researchers have proposed different theories regarding the origin of hydrogen sulfide in sewers. Whatever its source, hydrogen sulfide in sewers is transformed by bacteria living in biofilms attached to the concrete pipes and structures in sewers into sulfuric acid, which degrades concrete, causing billions of dollars worth of damage to sewers every year. The addition of superoxide dismutase (SOD) to sewers will greatly reduce this hugely expensive to repair damage to the concrete. Zinc/copper SOD is widely available as a commercial product from chemical suppliers, at prices that make the use of SOD in sewers a bargain, compared to repairing sewer damage, or compared to continuous admixture of inorganic chemicals that bind to hydrogen sulfide or sulfuric acid.

Extracted SOD may be admixed to H2S containing waste water by any means, including but not limited to, the admixture of copper/zinc exo-SOD to the sewer water, or by culturing SOD excreting microorganisms in the sewer water, or by the growth of said microorganisms attached by exopolysaccharides to an attachment medium placed in sewer water. Examples of these SOD excreting microorganisms include but are not limited to, Aspergillus species, Penicillium species, and Cryptococcus species. It would be advantageous to provide pre-cultured media for the microorganisms to cling to, including but not limited to, plastic mats, brushes, ropes, foams, and fiber bunches, and commercial products such as Zeeweed, so that they would not be swept away by the flowing sewer water.

Using SOD for this purpose would be less expensive than the currently used chemical additives, because the SOD does not bind itself to the hydrogen sulfide, but rather binds additional sulfur atoms to hydrogen sulfide repeatedly, without itself being bound to the hydrogen sulfide.

Another application for SOD removal of H2S is in removal of H2S from petroleum and natural gas refining plants and effluents. H2S removal from petroleum and natural gas is referred to as “sweetening.” Alkanolamines such as DEA, MEA, and MDEA are currently used for this purpose, but they have to be removed from sweetening plant waste water due to environmental protection laws. SOD biotransforms H2S via combining H2S+O2, to H2S2, H2S3, H2S4 and H2S5, which substances do not have to be removed from wastewater to legally discharge the treated water in countries with rigorous environmental protection laws.

### Biodegrading Substances that Contain Amide Groups

Enzymes called amidases biodegrade substances that contain amide groups, including but not limited to, polyurethanes and polyamides. Chemical stimulators will elicit the production and excretion of amidases in many microbes. These chemical stimulators include, but are not limited to, amides, acetamide, acrylamide, butyramide and urea. Organisms that can produce and excrete amidases include, but are not limited to, Pseudomonas species, Mycobacterium species, Rhodococcus species, Streptomyces species, Klebsiella species, Burkholderia species, Alcaligenes species, and Arthrobacter species.

### Biodegrading Nitrile Moiety Containing Substances

Biodegrading substances that contain nitrile groups, including but not limited to, carboxylated nitrile butadiene rubber (XNBR) and hydrogenated nitrile butadiene rubber (HNBR)

Many millions of protective XNBR nitrile rubber gloves are manufactured and disposed of every year, and many millions of tires containing HNBR are manufactured and disposed of every year. These products are very resistant to biodegradation, so it is a huge benefit to the environment to make them biodegradable. XNBR products can have biodegradation stimulating substances incorporated in them during their manufacture. Despite being very resistant to chemical penetration, XNBR has a number of moieties that can be readily biodegraded by ligninolytic systems, ester degrading enzymes, and nitrile biodegrading enzymes.

Therefore, any substance for enhancing biodegrading XNBR would optimally include the claimed inducers of the production and excretion of these enzymes and systems, and the claimed nutrients, followed by the subsequent mixing of the treated substance with the claimed microorganisms for the biodegradation of these moieties. HNBR is a hydrocarbon containing a hydrocarbon backbone, and nitrile side groups, and so is biodegradable by ligninolytic systems in combination with nitrile degrading enzymes, assisted by nutritional substances, when combined with the claimed fungi, yeast, or microbes.

### Definition of Basal Salts

The term basal salts as used herein means a mixture of elements in the form of water soluble compounds, said elements being necessary to organisms of every kind. Salts of nitrogen, calcium, magnesium, potassium, boron, colbalt, iron, manganese, molybdum, copper, and iodine are typically included in basal salt mixtures, in the form of water soluble compounds, often in the forms of compounds containing O, H2O, SO4 and Cl2, to render them soluble in water.

### Definition of Organically Assimilable Nitrogen Sources

Organically assimilable nitrogen sources means herin that a nutrient substance contains nitrogen in its composition, and said nitrogen is capable of being assimilated by microorganisms. The group of organically assimilable nitrogen sources comprises substances which include, but are not limited to, urea, nitrates, nitrites, ammonium compounds, and amino acids.

### Definition of Organically Assimilable Carbon Sources

Organically assimilable carbon sources means herin that a nutrient substance contains carbon in its composition, and said carbon is capable of being assimilated by microorganisms. The group of organically assimilable carbon sources comprises substances which include, but are not limited to, sugars, polyols, carbohydrates, fatty acids, and organic acids, and compounds which contain these substances as constituents.

### Definition of B Vitamins

B vitamins means herein substances which comprise a group of substances which contain B vitamins and their precursors and derivatives, including but not limited to, thiamin, biotin, bran, and substances which contain these substances as constituents.

### Definition of the Words Biodegrade, Biodegradation, Compost, Home Compost, Decompost, Mineralize, Bioremediate, and Biotransform

Used herein, all of these words shall mean to so affect a problematic, difficult to biodegrade recalcitrant to biodegradation substance by means of an enzyme, an enzymatic system, or by an organism or microorganism via the production of enzymes or enzyme systems, so as to render said substances less toxic, less hazardous, less corrosive, less harmful to the environment, or in any other way less problematic.

### Definition of Organic Substances

Organic substances as used herein shall mean carbon-containing compounds, as is usual, but also means compounds resulting from the activity of microorganisms, such as hydrogen sulfide and sulfuric acid.

### Limitations and Claims of the Patent

Nothing in the abstract, field of invention, background, description, embodiment formulas, specification, or other non-claim parts of this patent application shall be construed as limiting the scope of the invention. Only the claims attached to this document are meant to claim or limit any aspect of the invention.

1-16. (canceled)

17. A composition comprising one or more ingredients selected from a group consisting of tributyrin, triolein, fish oil, 16-hydroxyhexadecanoic acid, n-aliphatic primary fatty alcohols, polycaprolactone, aliphatic polyesters, linolenic acid, linoleic acid, alpha linolenic acid, plant polyesters, cutin, cutin derivatives, cutin monomers, omega hydroxy acids, 16-hydroxy palmitic acid, 9,16-dihydroxypalmitic acid, 10,16-dihydroxypalmitic acid, C18-hydroxy oleic acid, 9,10-epoxy-18-hydroxy stearic acid, 9,10,18-trihydroxystearate, suberin, cork, fruit skins, vegetable skins and their constituents and derivatives, hydroxy fatty acids, 16-hydroxy palmitic acid, 18-hydroxy stearic acid, juniperic acid, hexadecanol, vegetable oils, linseed oil, perilla oil, amides, acetamide and N-acetyl amide, zinc, zinc salts, butyrate, acetate, lactate, manganese peroxidase, and carbamide peroxide;
wherein, said composition stimulates the production and excretion of a lignolytic and/or other biodegrading enzymes in a microorganism or microorganisms;
wherein, said carbamide peroxide stimulates the production and excretion of enzyme superoxide dismutase;
wherein, said other biodegrading enzymes comprising one or more enzyme selected from a group consisting of esterase, lipase and/or cutinase;
wherein, said manganese peroxidase and said enzyme superoxide dismutase are used for degrading H₂S; and
wherein, the composition is used for degrading a harmful substance and/or in the manufacturing of an easily degradable ester containing plastic or an article made of ester containing plastic.

18. The composition as claimed in claim 17, wherein the composition comprising one or more ingredients selected from a group consisting of 16-hydroxyhexadecanoic acid and linoleic acid.

19. The composition as claimed in claim 17, wherein the lignolytic enzyme is laccase.

20. The composition as claimed in claim 17, wherein the lignolytic enzyme is manganese peroxidase.

21. The composition as claimed in claim 17, wherein the lignolytic enzyme is peroxidases.

22. The composition as claimed in claim 17, wherein the harmful substance is selected from a group consisting of petroleum, petroleum derived substances, natural gas derived substances containing ester moieties, polyethylene terephthalate, cellulose acetate, epoxy resins, polycarbonates, polytrimethylene furandicarboxylate, acrylate plastics, methyl methacrylate, sodium polyacrylate, polylactic acid, acrylics, polyethylene furanoate, polytrimethylene furandicarboxylate, polyester polyurethanes, polylactic acid, carboxylated nitrile butadiene rubber, including phalates, phthalates, polyhydroxy alkanoate (PHA), polybutylene succinate (PBS), polybutylene succinate adipate (PBSA), polybutylene adipate terephthalate (PBAT), Polycaprolactone (PCL), poly(ethylene adipate) (PEA), polyethylene naphthalate (PEN), and Hydrogen sulfide (H2S).

23. The composition as claimed in claim 17 for degrading a harmful substance, wherein the harmful substance is selected from a group consisting of ester group containing plastics, polyethylene terephthalate, epoxy resins, polyethylene furanoate, polytrimethylene furandicarboxylate, acrylate plastics, methyl methacrylate and sodium polyacrylate.

24. The composition as claimed in claim 17 for degrading a harmful substance, wherein the composition is mixed with the harmful substance in a proportion of about 0.01 gram to about 100 grams of the composition with a kilogram of the harmful substance to be degraded.

25. The composition as claimed in claim 17, wherein the composition further comprises one or more nutrient substances for the growth of microorganism, selected from a group consisting of a basal mineral salt mixture, a carbon source, a nitrogen source, and a vitamin;
wherein, said vitamin is selected from a group consisting of thiamine, biotin and a mixture thereof;
said carbon source is selected from a group consisting of fatty acids, polyols, sugars, organic acids, cellobiose and cellulose;
said nitrogen source is selected from a group consisting of ammonium nitrate, sodium nitrate, ammonium sulfate, urea and ammonia; and
wherein said substances feed and encourage the growth of said microorganism or microorganisms.

26. The composition as claimed in claim 25, wherein the composition is used for degrading a harmful substance, wherein the harmful substance is selected from a group consisting of petroleum, petroleum derived substances, natural gas derived substances containing ester moieties, polyethylene terephthalate, cellulose acetate, epoxy resins, polycarbonates, polytrimethylene furandicarboxylate, acrylate plastics, methyl methacrylate, sodium polyacrylate, polylactic acid, acrylics, polyethylene furanoate, polytrimethylene furandicarboxylate, polyester polyurethanes, polylactic acid, carboxylated nitrile butadiene rubber, including phalates, phthalates, polyhydroxy alkanoate (PHA), polybutylene succinate (PBS), polybutylene succinate adipate (PBSA), polybutylene adipate terephthalate (PBAT), Polycaprolactone (PCL), poly(ethylene adipate) (PEA), polyethylene naphthalate (PEN), and Hydrogen sulfide (H2S).

27. The composition of claim 17 for manufacturing an easily degradable ester containing plastic, wherein the composition is incorporated during the manufacture of said plastic.

28. The composition of claim 17 for manufacturing an easily degradable article, wherein the composition is incorporated during the manufacture of said article.

29. A composition for biodegrading a ton of ester containing plastic, wherein the composition comprises at least one ingredient selected from the group consisting of:
Cellulose—15 kg per ton of the substrate;
Refined glycerol—1.5 kg per ton of the substrate;
flaxseed oil—5 kg per ton of the substrate;
16-hydroxyhexadecanoic acid—0.8 kg per ton of the substrate;
potassium sulfate, anhydrous—1.4944 kg per ton of the substrate;
calcium chloride anhydrous—0.30496 kg per ton of the substrate;
potassium phosphate monobasic—0.1584 kg per ton of the substrate;
magnesium sulfate—0.1506 kg per ton of the substrate;
calcium carbonate—0.09296 kg per ton of the substrate;
ammonium tartrate—0.08936 kg per ton of the substrate;
manganese sulfate—0.01544 kg per ton of the substrate;
zinc sulfate—0.00772 kg per ton of the substrate;
boric acid—0.00548 kg per ton of the substrate;
potassium iodide—0.00076 kg per ton of the substrate;
thiamine hydrochloride—0.001 kg per ton of the substrate;
molybdenum disulfide—0.0002234 kg per ton of the substrate;
ferrous sulfate—0.00003488 kg per ton of the substrate;
cobalt chloride—0.00000222 kg per ton of the substrate;
copper sulfate pentahydrate—0.00000222 kg per ton of the substrate; and
sodium benzoate—0.00000222 kg per ton of the substrate.
